(19) United States
(12) Patent Application Publication
(10) Pub. No.: US 2005/0191503 A1
(43) Pub. Date: Sep. 1, 2005

(54) Polycarbosilane treatment of substrates

(76) Inventor: Brian A. Jones, South Jordan, UT (US)

Correspondence Address: THORPE NORTH & WESTERN, LLP., 8180 SOUTH 700 EAST, SUITE 200, P.O. BOX 1219, SANDY, UT, 84070, US

(21) Appl. No.: 11/031,978

(22) Filed: Jan. 7, 2005

Related U.S. Application Data
(60) Provisional application No. 60/548,753, filed on Feb. 27, 2004.

(51) Int. Cl. B32B 25/20

(52) U.S. Cl. 428/447

(57) ABSTRACT

A polycarbosilane functionalized substrate can comprise a substrate having a surface including surface oxide or surface hydroxyl groups, and a polycarbosilane layer covalently bonded thereto. The polycarbosilane layer can include a web of interconnected polycarbosilane groups wherein the carbon bonded silane portions of the polycarbosilane groups are alkylene moieties. Optionally, an additional polycarbosilane layer(s) can be applied to the polycarbosilane layer.

The present application claims the benefit of U.S. Provisional Application No. 60/548,753 filed 2/27/204, which is incorporated herein by reference.

The present invention is drawn to compositions, systems, and methods of treating various types of substrates, including inorganic substrates and certain organic substrates. An example includes treating metal or semi-metal oxide solid support material with a polycarbosilane coating material that is resistant to hydrolysis and thermal degradation, and further provides protection of the underlying metal or semi-metal oxide surface from similar breakdown processes. In further detail, the present invention provides methods of preparing precursor polycarbosilanes and bonding the precursor polycarbosilanes to an inorganic substrate to form polycarbosilane-modified substrates.

### BACKGROUND OF THE INVENTION

In liquid chromatography, a mobile phase is typically used to carry analytes through a separation column. The analytes, upon passing through the separation column, can interact with a stationary phase of reagent-modified solid support material. With respect to the stability of these columns, an ideal stationary phase would be inert to irreversible chemical reactions with the mobile phase and analytes, as well as to thermal degradation under the analysis conditions.

Silanes have been used for many years to modify silica surfaces. These compounds have been usually based on silanes substituted with various types of a broad class of organic groups typically for providing functionality to the silane, as well as varied hydrolyzable groups typically for attaching the silane to a solid support surface. Exemplary hydrolyzable groups have included halogens, triflates, alkoxy, acyl, oximes, amines, and amine salts.

Exemplary of silane attachment to a solid support material is the attachment of an organofunctional silane reagent to silica. Most of such bonding schemes involve the attachment of the silane reagent to the silica surface through respective reactive groups. For example, a hydrolyzable group and a silanol can interact to form a siloxane bond and the corresponding acid. Typically, silica modified as such includes the organosilanes attached at a density such that some of the silanol groups of the silica surface are prevented from further reaction due to steric hindrance from other organosilanes already bonded thereto. Often, a smaller organosilane is used as an “endcapper” to bond with silanols shielded from reaction with the larger functionalized organosilanes, but which otherwise would still be exposed. However, even with the use of encappers, gaps still remain in the organosilane coating that can lead to undercutting by active entities under use conditions. Ultimately, this can lead to strong adsorptive interactions with solutes under chromatographic conditions, or even to failure of the column. Many solid support modification techniques have been attempted to reduce these problems with varying degrees of success.

The problems set forth with respect to stability under use conditions are exacerbated further when the column is configured for use with more aggressive mobile phase additives and higher temperatures. Specifically, mobile phases that contain water, alcohol(s), salt(s), and/or pH adjusting additive(s), particularly in large amounts, can be very aggressive with respect to typical stationary phases known in the art. This is particularly true when the chromatographic separation occurs at elevated temperatures. In other words, with many of the reagent-bound solid supports currently used in the chromatographic arts, water, alcohol(s), salt(s), pH adjusting additive(s), and elevated temperature, among other additives and conditions, are known to break down reagent-bound stationary phase material, often sweeping the covalently-bound reagent from the column. Additionally, these same additives and conditions can also attack the underlying support material and dissolve their fragments, often leading to high backpressures, bed collapse, and column failure.

In accordance with the above, it would be desirable to provide materials for inorganic substrate modification that are more durable than many of the currently available surface modification materials. Particularly, in the area of surface modification for chromatography supports, it would be desirable to provide a material that can be used to modify the stationary phase of a chromatographic column, which protects the substrate from attack by more aggressive mobile phases.

### SUMMARY OF THE INVENTION

It has been recognized that it would be desirable to provide more durable solid support surfaces for chromatographic separation uses, as well as durable coatings and composites with respect to other applications. It has also been recognized that it would be useful to provide a stationary phase that includes coated solid supports that are resilient and resistant to attack by aggressive mobile phases. This can be accomplished by bonding polycarbosilane materials to substrates including surface-attachment moieties having a multiplicity of attachment points.

In accordance with these recognitions, a polycarbosilane functionalized substrate can comprise a substrate including a surface having surface oxide or surface hydroxyl groups, and a polycarbosilane layer covalently bonded to the surface. The polycarbosilane layer can include a web of interconnected polycarbosilane groups, wherein carbon linking portions of the polycarbosilane groups are alkylene moieties. Preferably, the polycarbosilane groups include one or both of tri- or tetracarbosilane groups, though tetra-, hexa-, hepta-, etc. carbosilanes can also or alternatively be used.

In another embodiment, a polycarbosilane functionalized substrate can comprise a substrate including a surface having surface oxide or surface hydroxyl groups, a first polycarbosilane layer covalently bonded to the surface, and a second polycarbosilane layer covalently bonded to the first polycarbosilane layer. The first polycarbosilane layer can include a first web of interconnected polycarbosilane groups and the second polycarbosilane layer can include a second web of interconnected polycarbosilane groups. The carbon linking portions of the polycarbosilane groups of the first and second webs are typically alkylene moieties. Again, preferably, the polycarbosilane groups include one or both of tri- or tetracarbosilane groups, though tetra-, hexa-, hepta-, etc. carbosilanes can also alternatively be used.

In another embodiment, a tricarbosilane precursor can comprise the structure: 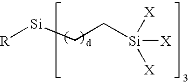
wherein each d is independently from 1 to 4, each X is independently halogen; triflate; lower alkoxy; acyl such as acetyl, trifluoroacetyl, or propionyl; oxime such as those bonded to silicon through oxygen, with the oxygen also bonded to a disubstituted amine, e.g., dimethylamino or pyrrolidino; amine such as secondary amines, e.g., dimethylamino or pyrrolidino; or amine salt including corresponding aminosilanes with acid added, for example, HCl or triflic (trifluoromethanesulfonic) acid, similar structures formed using halogen substituted silanes with pyridine added, or additional carbosilane groups; and R is methyl, ethyl, straight or branched C₃ to C₃₀ alkyl, hydroxy-substituted alkyl, cyanoalkyl, fluoroalkyl, mercaptoalkyl, ester-substituted alkyl, carboxylic acid substituted alkyl, aminoalkyl, ether-substituted alkyl, epoxy-substituted alkyl, silyl-substituted alkyl, phosphinoalkyl, phenyl and substituted phenyl including cyano, fluoro, or nitro substituted phenyl, and combinations thereof.

In another embodiment, a method of preparing a polycarbosilane functionalized substrate can comprise multiple steps. Such steps can include forming a first group of polycarbosilane precursor monomers, attaching the first group of polycarbosilane precursor monomers to a substrate including a surface having surface oxide or surface hydroxyl groups, and forming a first web of interconnected polycarbosilane groups from the first group of polycarbosilane precursor monomers. The first group of polycarbosilane precursor monomers can be attached to the surface through tethering silicon-oxygen bonds, and can also include linking siloxane bonds interconnecting adjacent polycarbosilane groups.

Additional features and advantages of the invention will be apparent from the detailed description that follows, which illustrates, by way of example, features of the invention.

### BRIEF DESCRIPTION OF THE DRAWINGS

FIG. 1 illustrates column stability at high temperature and high water content using silica supports modified by a web of interconnected polycarbosilane groups in accordance with embodiments of the present invention;

FIG. 2 illustrates column stability at high temperature and 100% water content using silica supports modified by a web of interconnected polycarbosilane groups in accordance with embodiments of the present invention;

FIG. 3 illustrates column selectivity using silica supports modified by a web of interconnected polycarbosilane groups in accordance with embodiments of the present invention;

FIG. 4 illustrates separation of analgesics at low pH and elevated temperature using silica supports modified by a web of interconnected polycarbosilane groups in accordance with embodiments of the present invention; and

FIG. 5 illustrates column stability at high pH using silica supports modified by a web of interconnected polycarbosilane groups in accordance with embodiments of the present invention.

### DETAILED DESCRIPTION OF THE PREFERRED EMBODIMENT(S)

Reference will now be made to the exemplary embodiments, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention. It is also to be understood that the terminology used herein is used for the purpose of describing particular embodiments only. The terms are not intended to be limiting unless specified as such.

It must be noted that, as used in this specification and the appended claims, the singular forms “a,” “an,” and “the” include plural referents unless the content clearly dictates otherwise.

The terms “polycarbosilane group(s)” or “polycarbosilanes” include structures with three or more carbosilane moieties within a common molecular structure, i.e, at least tricarbosilanes. For example, the term “tricarbosilane” refers to a group having a central silicon atom that has three carbosilane or organic carbon linking and silicon containing groups attached thereto. The term “tetracarbosilane” refers to a group having a central silicon atom that has four carbosilane or organic carbon- and silicon-containing groups attached thereto. Further, tricarbosilanes and tetracarbosilanes can have pendent carbosilanes attached thereto to form pentacarbosilanes, hexacarbosilanes, etc., as will be explained in more detail herein. The silane groups can be reacted with surface oxide or surface hydroxyl groups of a substrate to form a tethering siloxane bond or tethering silicon-oxygen bonds. Further, these materials can be reacted with silanes to form linking siloxane bonds, can be hydroxylated (hydrolyzed), or can include reactive groups such as halogen, triflate, alkoxy, acyl, oxime, amine, or amine salts, for example.

The term “organosilane” refers to silane groups that are typically bound directly to carbon, which may be part of a larger structure containing additional silane groups.

The term “tethering siloxane bond” or “tethering silicon-oxygen bond” refers to the silicon-oxygen bonds that attach a substrate including surface oxide or surface hydroxyl, e.g., metal or semi-metal oxide surfaces, to polycarbosilane groups. If the surface is silica, then a siloxane bond will form, which includes a silicon-oxygen bond. However, if the surface is something other than silica, such as alumina, then a siloxane bond will not be present due to the absence of the silicon atom at the surface of the substrate. Thus, the term “tethering silicon-oxygen bond” can alternatively be used.

The term “linking siloxane bonds” refers to siloxane bonds that link adjacent polycarbosilane groups to one another.

The term “metal or semi-metal oxide” refers to metal oxides and semi-metal oxides, such as silica (including beads and gel), silicates, zirconia, titania, alumina, nickel oxide, chromium oxide, tin oxide, lead oxide, germanium oxide, ceramics, glass supports, etc.

The term “web of interconnecting polycarbosilane groups” refers to compositions where both interlinking siloxane bonds and tethering siloxane bonds (directly or through an intermediate web) are present.

The term “polycarbosilane barrier layer” refers to polycarbosilane layers that can be formed from polycarbosilanes having at least organosilane groups. A polycarbosilane barrier layer may optionally include a bulky, e.g., low or non-reactive larger groups such as hydrophobic alkyl, etc., or functional groups attached to the central silicon atom of a tricarbosilane.

The term “polycarbosilane functional layer” refers to polycarbosilane layers that can be formed from polycarbosilanes having at least three organosilane groups, but also include at least one bulky or functional group on at least a portion of the silicon atoms.

The terms “surface oxide or surface hydroxyl groups” and “surface oxides and/or surface hydroxyl groups” can be used interchangeably. These terms do not infer that only one or the other is present at a substrate surface. For example, a surface having surface oxide groups, surface hydroxyl groups, or both surface oxide groups and surface hydroxyl groups would be included under these terms.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight ratio range of about 1 wt % to about 20 wt % should be interpreted to include not only the explicitly recited limits of 1 wt % and about 20 wt %, but also to include individual weights such as 2 wt %, 11 wt %, 14 wt %, and sub-ranges such as 10 wt % to 20 wt %, 5 wt % to 15 wt %, etc.

The present invention is drawn to a polycarbosilane functionalized substrate that can comprise a substrate including a surface having surface oxide and/or surface hydroxyl groups, and a polycarbosilane layer covalently bonded to the surface. The polycarbosilane layer can include a web of interconnected polycarbosilane groups, wherein carbon linking portions of the polycarbosilane groups are alkylene moieties. Preferably, the polycarbosilane groups include one or both of tri- or tetracarbosilane groups, though tetra-, hexa-, hepta-, etc. carbosilanes can also or alternatively be used. The web of interconnecting polycarbosilane groups can be applied as a single web layer. The polycarbosilane layer can be a polycarbosilane barrier layer or a polycarbosilane functional layer.

In another embodiment, a polycarbosilane functionalized substrate can comprise a substrate including a surface having surface oxide and/or surface hydroxyl groups, a first polycarbosilane layer covalently bonded to the surface, and a second polycarbosilane layer covalently bonded to the first polycarbosilane layer. The first polycarbosilane layer can include a first web of interconnected polycarbosilane groups and the second polycarbosilane layer can include a second web of interconnected polycarbosilane groups. The carbon linking portions of the polycarbosilane groups of the first and second webs are typically alkylene moieties. Again, preferably, the polycarbosilane groups include one or both of tri- or tetracarbosilane groups, though tetra-, hexa-, hepta-, etc. carbosilanes can also or alternatively be used. In one embodiment, the first polycarbosilane layer is a polycarbosilane barrier layer, and the second polycarbosilane layer is a polycarbosilane functional layer.

These embodiments being described, the materials set forth herein provide very durable surfaces for use in chromatographic separations over a relatively wide range of pH conditions and temperatures compared to traditional silane derivatizing groups. These materials can be applied to virtually any substrate with surface oxide and/or hydroxyl groups, e.g., metal or semi-metal oxides known to be used in separation columns. With specific reference to silica, virtually any silica base material can be used as a precursor solid support material, including both particulate and monolithic material, as well as fused silica or quartz tubing.

Though a primary use of the materials of the present invention is chromatography at more aggressive fluid conditions, e.g., high temperature, low or high pH, high concentration of water or alcohols, etc., the compositions of the present invention can also be used for treating fused silica tubing for capillary electrophoresis or gas and liquid chromatography applications, or any other use involving corrosive fluids. Thus, the compositions and methods of the present invention are not limited to chromatography, as any application involving immersion of a metal or semi-metal oxide material into a corrosive liquid, supercritical fluid, or gaseous environment, where the substrate should be protected from chemical corrosion or breakdown will benefit. Further, other coating applications will also be benefited by the barrier and/or functional polycarbosilane layers of the present invention, as will be discussed hereinafter.

In addition to the polycarbosilane-functionalized substrates described herein, a method of preparing a polycarbosilane functionalized substrate is disclosed, and can include steps of forming a first group of polycarbosilane precursor monomers, attaching the first group of polycarbosilane precursor monomers to a substrate including a surface having surface oxide or surface hydroxyl groups, and forming a first web of interconnected polycarbosilane groups from the first group of polycarbosilane precursor monomers. The first group of polycarbosilane precursor monomers can be attached to the surface through tethering silicon-oxygen bonds, and can also include linking siloxane bonds interconnecting adjacent polycarbosilane groups.

In accordance with this, the method can further comprise the step of hydrolyzing the first web of interconnected polycarbosilane groups after the attaching step to form a hydroxylated first web. After hydrolysis, subsequent steps of forming a second web of interconnected polycarbosilane groups from a second group of polycarbosilane precursor monomers can be carried out. For example, steps can include attaching a second group of polycarbosilane precursor monomers to the hydroxylated first web through linking siloxane bonds; and forming a second web of interconnected polycarbosilane groups from the second group of polycarbosilane precursor monomers. The second web can also include linking siloxane bonds interconnecting adjacent polycarbosilane groups (both within the second web and from the second web to the first web). With the second web in place, a step of hydroxylating the second web of interconnected polycarbosilane groups after attaching the second web to the hydroxylated first web can also be carried out. This general process can be repeated, adding layer upon layer if desired.

Polycarbosilanes

Various types of polycarbosilanes, such as tri- and/or tetracarbosilanes, can be prepared to form the polycarbosilane coated substrates of the present invention. Formula 1 below depicts a general arrangement of tricarbosilane precursor monomers that can be used to form the polycarbosilane barrier layer and/or the polycarbosilane functional layer in accordance with embodiments of the present invention: 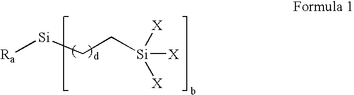
In Formula 1 above, when a is 1, b is 3; or when a is 0, b is 4. Thus, Formula 1 can represent a tricarbosilane having three organosilane moieties and a functional or bulky group (R), or alternatively, Formula 1 can represent a tetracarbosilane having four organosilane moieties. Also in Formula 1, each d can independently be from 1 to 4 for each of the three or four individual organosilane moieties, and each X can individually represent precursor moieties such as halogens, triflates, alkoxy, acyl, oximes, amines, amine salts, and even other carbosilanes, for example. Thus, if one or more of the X groups are carbosilane group(s), then the tricarbosilanes of Formula 1 can actually be referred to as tetracarbosilanes, pentacarbosilanes, hexacarbosilanes, etc. Likewise, if one or more of the of the X groups are carbosilane group(s), then the tetracarbosilanes of Formula 1 can actually be referred to as pentacarbosilanes, hexacarbosilanes, heptacarbosilanes, etc. In other words, the nomenclature can depend on how many carbosilane groups are present on a common molecular structure prior to forming webs of interconnencting polycarbosilanes in accordance with embodiments of the present invention. However, polycarbosilanes in accordance with embodiments of the present invention preferably include at least three carbosilane groups attached to a common central silicon atom.

An exemplary composition in accordance with Formula 1 where a is 1 and b is 3 is shown as Formula 2 below: 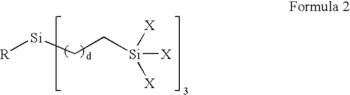
In Formula 2, a polycarbosilane having three organosilane moieties and a functional or bulky group is shown. Specifically, d can independently be from 1 to 4 for each of the three individual organosilane moieties, and each X can individually represent precursor moieties being selected from the group consisting of halogens, triflates, alkoxy, acyl, oximes, amines, amine salts, and even other carbosilanes. In accordance with one specific embodiment, X can be chloro, and R can be a C₈ or C₁₈ alkyl group, for example. In another embodiment, one or more X can be methyl, alkyl, or another alkylsilyl group.

Formula 3 below depicts an exemplary preparation scheme of a tetracarbosilane precursor monomer in accordance with Formula 1, as follows: 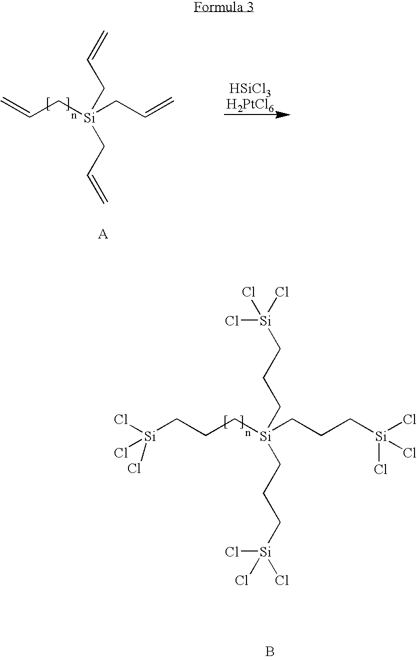
In Formula 3 above, n can be from 1 to 3. Composition A of Formula 1 is precursor molecule that can be used to form the tetracarbosilane precursor monomers of Composition B. Though three of the four carbo- or carbon linking portions of the tetracarbosilane precursor monomers shown are propylene, it is understood that these chains can independently be from C₂ to C₆ alkylene, for example. Additionally, the four organosilane groups shown branching from the central silicon atom, as shown in Composition B, are heavily chlorinated at this stage. Other reactive groups can also be used, as described herein. With specific reference to Composition B as it relates to Formula 1, a is 0, b is 4, d is 2 for three of the organosilane groups and 3, 4, or 5 for the remaining organosilane group, and X is chloro.

Formulas 4 and 5 below depict exemplary preparation schemes of alternative tricarbosilane precursor monomers in accordance with Formula 1. Specifically, the preparation of two exemplary compositions can include propylene carbo- or carbon linking groups (Formula 4) and ethylene carbon bonded groups (Formula 5), shown as follows: 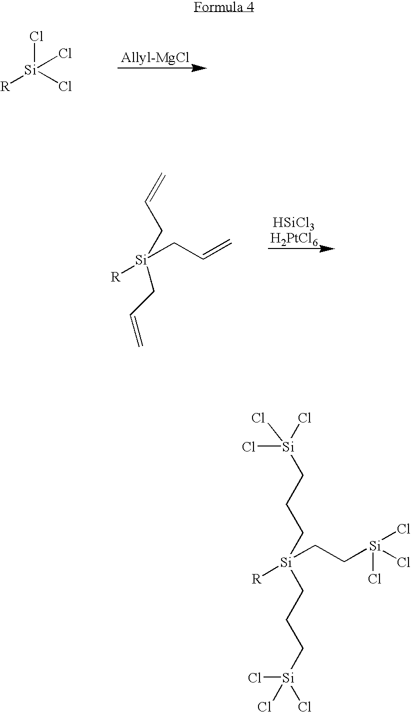 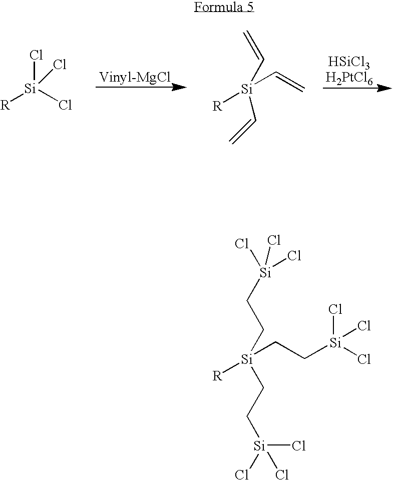
In Formulas 4 and 5 above, R can represent a wide range of functional or bulky groups such as straight or branched C₁ to C₃₀ alkyl such as octyl or octadecyl, cyanoalkyl such as cyanopropyl, fluoroalkyl, phenyl, or any other functional or bulky groups compatible with the reactants used to prepare the tricarbosilanes, including less stable groups blocked with suitable protecting groups), and including other R groups described herein. Though three of the four carbon bonded portions of the tricarbosilane precursor monomers shown are at least ethylene, it is understood that these chains can independently be from C₂ to C₆ alkylene, for example. Additionally, the three organosilane groups shown branching from the central silicon atom of the polycarbosilane precursor monomers are heavily chlorinated at this stage, though other reactive groups can also be used. With specific reference to the Formula 4 composition as it relates to Formula 1, a is 1, b is 3, d is 2, and X is chloro. With specific reference to the Formula 5 composition as it relates to Formula 1, a is 1, b is 3, d is 1, and X is chloro.

Substrates Functionalized with Polycarbosilane Layer(s) of Interconnecting Polycarbosilane Groups

In accordance with embodiments of the present invention, polycarbosilane groups prepared in accordance with Formula 1 can be polymerized to form a web layer of interconnecting polycarbosilane groups. In one embodiment, the web can be formed and attached to a substrate surface. However, preferably, individual polycarbosilane groups can be attached to the substrate, followed by a hydrolyzing and/or condensing step to form the web. These compositions can be covalently bonded to the substrate through tethering siloxane bonds, if the substrate includes a silica surface, for example. In one embodiment, at least one of the polycarbosilane groups can be tethered to the surface of the substrate through two or three alkylene substituted moieties, forming at least one tethering siloxane bond through each of the two or three alkylene substituted moieties. In a more detailed aspect, at least one of the two or three carbon bonded groups individually forms two or three tethering siloxane bonds.

To provide a specific example, by reacting multiple active monomers prepared in accordance with Formula 3 with dried silica, a composition approximated by Formula 6 below can be formed:

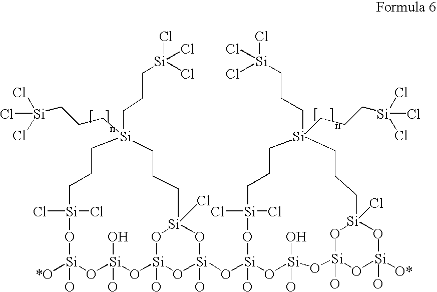

In Formula 6, n can be from 1 to 3, and an asterisk (*) symbol is used to suggest additional bonding that is outside of the two-dimensional section depicted by the Formula. It is to be noted that arrangement of the matrix of Formula 6 is exemplary. For example, at certain locations at the silica surface, certain silanol groups are shown as unreacted. The location of the unreacted silanol groups can be somewhat random, as it is difficult to react each an every silanol group present on a silica surface for steric reasons. Additionally, the Formula 6 composition merely depicts a section of the surface of the silica, and thus, only a two-dimensional sectional view of the polycarbosilane barrier layer in this precursor state is likewise shown. The polycarbosilane barrier layer will bond to the surface in three dimensions. Additionally, though the invention is drawn to the modification of substrates having surface oxide and/or surface hyrdroxyl groups, a silica surface is shown merely to favorably exemplify the practice of the present invention.

This being stated, the Formula 6 composition can be further processed by removing excess reagent by washing with dry toluene, and then the heavily chlorinated surface can be hydrolyzed and neutralized by extensive washing with water. This can result in a composition approximated by Formula 7 below, where the chlorinated surface is modified to a more hydroxylated structure: 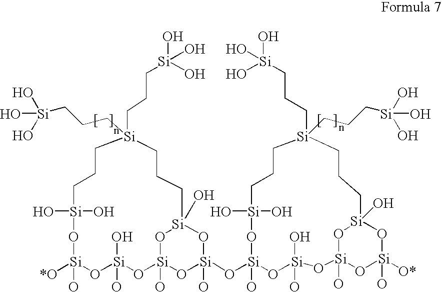
Again, in Formula 7 above, n can be from 1 to 3, and an asterisk (*) symbol is used to suggest additional bonding that is outside of the two-dimensional section depicted by the Formula.

In addition to the tethering of the polycarbosilane groups to the surface oxide or hydroxyl groups, the polycarbosilane groups can be linked to one another. For example, the web of interconnecting polycarbosilane groups can include a first polycarbosilane group that is bonded to a second polycarbosilane group through a first linking siloxane bond. In further detail, the web of interconnecting polycarbosilane groups can further include a third polycarbosilane group and a fourth polycarbosilane group, wherein the third polycarbosilane group is bonded to the first polycarbosilane group through a second linking siloxane bond, and wherein the fourth polycarbosilane group is bonded to the second polycarbosilane group through a third linking siloxane bond. This embodiment sets forth a pattern of linking of polycarbosilane groups to one another to create polymeric three-dimensional coating composition that is both tethered to the surface of the substrate, and which is interlinked. To further illustrate the interlinking that can occur, between some of the tetracarbosilane groups, two or even three linking siloxane bonds can link two adjacent tetracarbosilane groups together.

To continue the specific example following Formula 7, which represents a section of a hydroxylated polycarbosilane barrier layer in a second precursor state, i.e. without the formation of siloxane bonds, further modification can be carried out. Specifically, the composition approximated by Formula 7 can be dried under vacuum at ˜200° C. or catalyzed with acid, base, or tin catalysts in solution, which results in condensation of some of the silanol groups that are in closer proximity to form siloxane bonds, as shown in Formula 8 below: 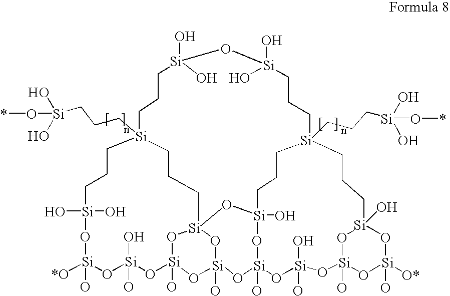
In Formula 8 above, n can be from 1 to 3, and an asterisk (*) symbol is used to suggest additional bonding that is outside of the section depicted by the Formula. The composition of Formula 8 depicts an exemplary portion of a polycarbosilane barrier layer that can be prepared in accordance with embodiments of the present invention. Again, at certain locations at the silica surface and elsewhere in the matrix, certain silanol groups are shown as unreacted. The location of the unreacted silanol groups can be somewhat random, as it is difficult to react each an every silanol group present on a silica surface for steric reasons. Silanol groups flanking the molecule are shown as reacted to adjacent groups that are not shown as well. Some of these silanol groups can be reacted to other hydroxylated carbosilane groups of the interconnecting web of carbosilane groups though linking siloxane bonds, to the silica surface through tethering siloxane bonds, or to a subsequently applied carbosilane functional layer through linking siloxane bonds. Additionally, though not shown, the materials formed can be endcapped with small groups, such as trimethylsilyl agents, to reduce the overall residual silanol content, as is generally known in the art.

With respect to the individual tetracarbosilane groups, each typically includes four alkylenesilane moieties, such as C₂ to C₆ alkylenesilane moieties. The alkylenesilane moieties can bond the tetracarbosilane to other polycarbosilanes, or to the surface oxide and/or surface hydroxyl groups through siloxane or silicon-oxygen bonds. In some embodiments, at least a portion of the polycarbosilane groups can include an alkylene group that is terminated by a functional or bulky group, thereby providing additional functionality to the solid support substrate. Exemplary functional or bulky groups include straight or branched C₁ to C₃₀ alkyl, diol-substituted alkyl, cyanoalkyl, fluoroalkyl, phenyl, other groups described herein, or combinations thereof.

In accordance with an alternative exemplary embodiment of the present invention, a polycarbosilane barrier layer including polycarbosilane groups having bulky or functional groups attached thereto can be bonded to a substrate. For example, the chlorinated polycarbosilane precursor monomers prepared in accordance with Formula 4 can be reacted directly with silica to form a polycarbosilane functional layer bonded to the surface, or with the polycarbosilane barrier layer prepared as described previously. An exemplary embodiment showing the polycarbosilane functional layer bonded to a silica surface is provided in Formula 9 below (after hydroxylating the chlorinated polymer and causing linking siloxane bonds to form): 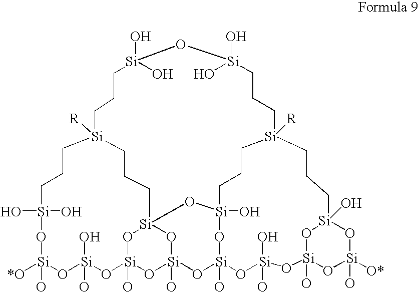
In Formula 9 above, again, R can represent a wide range of functional or bulky groups such as straight or branched C₁ to C₃₀ alkyl, diol-substituted alkyl, cyanoalkyl such as cyanopropyl, fluoroalkyl, phenyl, or any other functional or bulky groups compatible with the reactants used to for the polycarbosilanes, including less stable groups blocked with suitable protecting groups and others described elsewhere herein.

Substrates Functionalized with Multiple Polycarbosilane Layers of Interconnecting Polycarbosilane Groups

In accordance with embodiments of the present invention, reactive carbosilane groups prepared in accordance with Formula 1 can be polymerized to form multiple web layers of interconnecting polycarbosilane groups. In this embodiment, a polycarbosilane barrier layer is typically attached to a substrate including surface oxide and/or surface hydroxyl groups through tethering siloxane bonds, and a subsequently applied polycarbosilane functional layer is typically attached to the polycarbosilane barrier layer through linking siloxane bonds. This being stated, more than two layers of materials can be applied. Additionally, in one embodiment, one of the two types of layers might be applied in multiple layers.

For convenience, the web of interconnected polycarbosilane groups are discussed with respect to a first web, which in one embodiment includes the polycarbosilane barrier (or primer) layer, and a second web, which in this embodiment includes the polycarbosilane functional layer. However it is to be understood that the first web and the second web can be of the same type of material, and additionally, more than merely two layers of material can be applied and attached to substrates in accordance with embodiments of the present invention.

With respect to the first web of interconnecting polycarbosilane groups, the description provided previously with respect to substrates functionalized with a single web layer of interconnecting polycarbosilane groups are applicable to this embodiment. In addition to the linking siloxane bonds that connect the polycarbosilane groups together in the polycarbosilane barrier layer, linking siloxane groups can also be used to interconnect the two respective webs together. In one embodiment, the first web and the second web of interconnected polycarbosilane groups can include organosilane groups having precursor moieties. Such precursor moieties include those selected from the group consisting of halogens, triflates, alkoxy, acyl, oximes, amines, and amine salts. After formation of the web, these precursor moieties can be hydroxylated as described previously.

An exemplary embodiment depicting multiple layer composition in accordance with this embodiment is shown in Formula 10. Specifically, a reaction similar to that used to covalently bond the polycarbosilane barrier layer to the surface can be performed to bond a polycarbosilane functional layer to the polycarbosilane barrier layer. An exemplary resulting structure is shown in Formula 10 below: 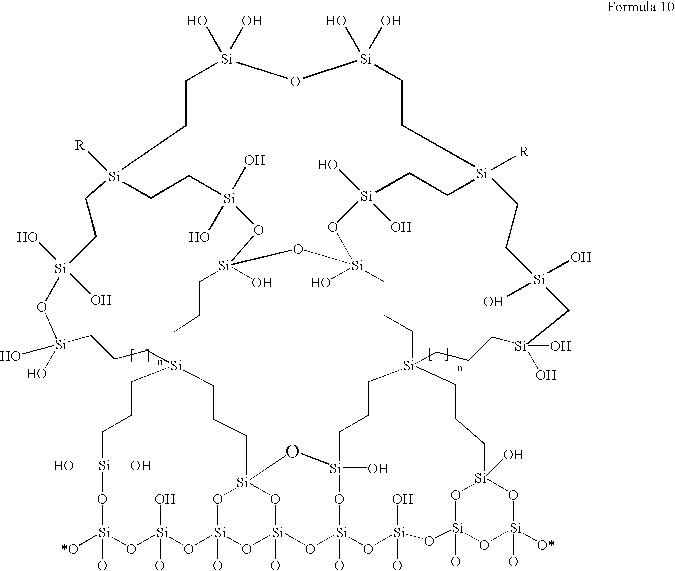
In Formula 10, R can be a bulky or functional group as previously described, n can be from 1 to 3, and an asterisk (*) symbol is used to suggest additional bonding that is outside of the section depicted by the Formula. It is to be noted that arrangement of the matrix of Formula 10 is exemplary. Additionally, the Formula 10 composition merely depicts a section of the surface of the silica, and thus, only a two dimensional sectional view of the polycarbosilane barrier layer in this precursor state is likewise shown. For example, the composition does not show interlinking that would occur between polycarbosilane groups that would be adjacent to this structure, and which are not shown. Additionally, Formula 10 is shown as fully hydroxylated, and as such, several intermediate steps are not shown, as they have been shown and described previously. Additionally, though not shown, the materials formed can be endcapped with small groups, such as trimethylsilyl agents to reduce the silanol content, as is generally known in the art.

Again, it is to be emphasized that the formulas shown are exemplary, as various alkylene groups, silanol groups, siloxane groups, etc., can be present. Further, the formation of these structures will be statistically controlled with respect to where silanol groups result and siloxane bonds occur. The invention is not drawn toward precisely controlling the location of these bonds within the structure, but rather, is drawn to the formation of the polycarbosilane-attached substrates described herein. Additionally, the structures shown are in two dimensions and only depict a piece of the interconnecting web of polycarbosilanes. The actual structures are three-dimensional and are difficult to depict as two dimensional structures. Other variations can include the degree of functionality, the composition and nature of leaving groups, etc. Further, similar materials can be used which are assembled during the hydrosilation process, or may be further purified or fractionated through vacuum distillation, depending on their molecular size and physical properties. Further, variations in the degree and nature of branching are also considered within the scope of the present invention. More generally, as the polycarbosilane-attached substrates of the present invention are described as they are assembled via a stepwise synthesis process, variation in functionality can be engineered by the choice of reactants in each step, as would be known to one skilled in the art after considering the present disclosure.

Though silica is described throughout in exemplary embodiments, the invention is drawn toward the modification of substrates having surface oxide and/or surface hydroxyl groups. Thus, as the invention has resulted in the production of materials capable of multiple point bonding, stable materials can be obtained in cases where the bond energy is not as strong as with a silicon oxide surface. For example, surfaces of alumina, titania, and zirconia, chromium oxide, tin oxide, lead oxide, germanium oxide, ceramics, as well as others modified with the web of interconnecting polycarbosilanes also show stability against breakdown under harsh conditions.

Chromatography

As inorganic supports are often used in chromatography and other bind-release separation technologies, there is often required an interface between organic materials and inorganic materials. Traditionally, silanes have been used to bridge organic and inorganic moieties, e.g., typically single silanes having three or fewer inorganic-binding moieties, and at least one organic moiety attached to the central silicon atom. This interface can significantly contribute to the durability of the system. Dry strength of these interface bonds is one factor to consider when determining whether a material will be effective for use, but is not as important as the strength of these type of bonds under water attack. For example, surfaces such as silicon dioxide have a natural affinity for water, and thus, water will naturally migrate to this polar surface, causing weakening of these interfacial bonds. In accordance with embodiments of the present invention, by using polycarbosilanes to form a web of interconnected tri- and/or tetracarbosilane groups, more interconnected binding locations are realized, and thus, weakening of these interfacial bonds is made more difficult, even in more extreme environmental conditions.

Thus, the compositions and methods of the present invention can be favorably exemplified with respect to their use in separation columns, particularly in applications where more extreme conditions are desired for use, e.g., higher temperature, more extreme pH levels, etc. In other words, because of the high stability of the materials of the present invention, several benefits can be achieved. Examples include high thermal stability, more effective selectivity tuning, faster analysis, less organic modifier required (though not precluded), wider isothermal and temperature programming ranges, etc. Additionally, particularly under more moderate separation conditions, extended column or reagent-modified solid support lifetime can also be realized. Still further, a wide pH range can be used for separations in accordance with embodiments of the present invention. Exemplary embodiments where this property is beneficial include ion suppression for acids, ion suppression for amines, and column regeneration by elution of contaminants at pH extremes, e.g., separating basic analytes at high pH can provide increased loading, increased retention, and/or increased resolution.

Polycarbosilane-functionalized solid supports in accordance with embodiments of the present invention compare favorably against many commercially available products. For example, a polydentate-modified silica having a general formula as described with respect to Formula 10, where R is C₁₈ and n is 1, can be stable at 200° C. and/or at from pH 1 to pH 12. This system provides a simple surface coating that works on virtually any silica, as well as on other solid support materials with improved results. The underlying particle structure can remain undisturbed, and stability at low and high pH as well as at high temperature can be realized. Conversely, other materials that perform favorably against the above polydentate-modified silica have certain drawbacks. For example, polymeric DVB (divinyl benzene) with compatible column hardware is effective for use at from pH 0 to pH 14, but is only stable to 150° C. Alternatively, Hypercarb™ by Thermo Electron Corporation is stable to 200° C. with compatible hardware, but exhibits selectivity vastly different than seen with traditional silica columns. Sterically hindered silane modified silica, such as Agilent's Stable Bond™, is particularly useful at low pH and moderately high temperatures, but shows little stability under high pH conditions. Hybrid organically-modified silica, such as Waters' Xterra™, is only stable to about 85° C. and exhibits phase loss and silica backbone breakdown under reverse phase conditions at higher temperatures. With the Waters' Xterra™ technology, each particle type must be optimized, and the incorporation of organic functionality within the solid matrix creates defects which can cause the particle strength to be partially compromised.

Zirconia solid supports, while chemically stable, are not recommended for temperature programmed conditions because of excessive bleed. Products introduced to date based on zirconia particles have been coated with crosslinked organic polymers lacking stabilizing covalent bonds to the underlying support. Silica, on the other hand, is a solid support material that is widely accepted in the industry and is quite predictable, e.g., high efficiency, available in a wide range of dimensions (particle sizes, pore sizes, surface areas, etc.), and exhibits high particle strength. Chromatographic tests have shown that silica treated with polycarbosilanes of the present invention exhibits selectivity similar to other traditional silica based column packing materials, but stability against hydrolytic or thermal breakdown is greatly enhanced.

Native silica is known to have a solubility in water vs. pH as follows: pH 6 is about 120 mg/L, pH 7 is about 120 mg/L, pH 8 is about 125 mg/L, pH 9 is about 150 mg/L, pH 9.5 is about 180 mg/L, pH 10 is about 460 mg/L, and pH 10.5 is about 875 mg/L. Thus, above about pH 9.5, the solubility of silica in water begins to significantly increase. Additionally, silica is known to have a solubility in water vs. temperature as follows: 0° C. is about 30 mg/L, 25° C. is about 120 mg/L, 50° C. is about 225 mg/L, and 75° C. is about 340 mg/L. The dissolution rate of silica is related to more than just its bulk solubility in the fluid. For example, surface area (typically 150 to 300 m²/gm for chromatographic silica), fluid flow across the surface, water concentration, pH, etc., can all play a role in the silica dissolution rate. Thus, the environmental stresses that silica support materials are subjected to during use can be mitigated using embodiments of the present invention such that its inherent chromatographically desirable properties can be more fully utilized. For example, the polydentate-bonded silica particles can be prepared that exhibit improved hydrolytic and thermal stability. Further, reverse phase operation with silica column selectivity can be performed at temperatures to at least 200° C. and/or a pH range of at least pH 1-12. Though the above exemplary embodiment relates primarily to silica, other solid support stability and durability can also be improved in accordance with embodiments of the present invention.

Other Applications

Though the barrier coating and/or functional coating compositions of the present invention are particularly useful in chromatography applications, there are other valuable uses for these materials in the form of substrate coatings, barrier layers over which additional coatings may be applied, crack fillers, corrosion protection barriers, treatments for surfaces which include other materials (including fillers and/or pigments), and additives for use with primers, paints, inks, dyes, adhesives, organic monomers (such as acrylics) prior to formation of their respective polymers, polymers prior to processing into a final product, and composites or materials used to form composites with the polycarbosilanes of the present invention. These materials can also be incorporated into polymers or substrate backbones, such as polyesters or concrete, or can be used as reactive intermediates for silicone resin synthesis. Other possible uses of these materials would be apparent to one skilled in the art after considering the present disclosure.

More specifically, application of the materials of the present invention to substrates can include application to such substrates as textiles, carpets, carpet backing, upholstery, clothing, sponges, plastics, metals, surgical dressings, masonry, silica, sand, alumina, titanium dioxide, calcium carbonate, wood, glass beads, tiles, floors, curtains, marine products, tents, backpacks, roofing, siding, fencing, trim, insulation, wall-board, trash receptacles, outdoor gear, water purification systems, and soil, for example. In addition, articles treatable with the compounds can also include, air filters and materials used for the manufacture thereof, aquarium filters, fiberglass ductboard, polyurethane and polyethylene foam, sand bags, tarpaulins, sails, ropes, wood preservatives, plastics, adhesives, paints, pulp, paper, and non-food or food contacting surfaces in general.

The following provides still a more specific list of exemplary applications for the polycarbosilane barrier and/or functional layers of the present invention. Such substrates include concrete, such as concrete water conduits and concrete storm and sewer pipes; dental items such as dentures, retainers, and instruments; marble slabs such as for building fascia, tombs, and floors; statues and exposed art work; exterior building finishing products including brick, stone, Dryvit systems, and stucco finish as well as roofing papers, tiles, metals, and shingles; waterproofing material; textile raw materials such as blended cotton before or after picking machines make the cotton into rolls or laps; food packaging and containers; and bio-films and adhesives (tapes and silicone wafers). These examples are provided to illustrate the versatility of the coatings of the present invention. However, of particular advantage is the application of these coatings to substrates where there is a need for a more durable and more hydrolytic degradation resistant bond to a surface than is available with previously available materials, e.g., mono-, di-, or trifunctional silane coupling agents.

With respect to the above-mentioned embodiments and others, treatment of many of these substrates can generally involve contacting or mixing the article to be treated with a solution of a polycarbosilane in the presence of nascent or added water for a period of time sufficient for permanent bonding of the active polycarbosilane ingredient (or portion thereof to the article. Generally, treatment can begin immediately upon contact. Preferably, the reaction time can be from about 15 seconds to about 48 hours. In one embodiment, a large glass substrate article can be dipped into such a polycarbosilane solution for from 1 to 2 minutes and then dried. Other substrate types can be dipped for shorter or longer periods of time. For example, a fabric may pass through a solvent bath of a polycarbosilane composition at a rate of 40 yards per minute or more, and after dipping, excess solution may be gently wiped or rinsed off. Alternatively, a polycarbosilane solution can be sprayed on a substrate, wiped onto a substrate, or otherwise applied using a sponge or fabric, etc. For example, when spraying onto fibers, these solutions can be used in addition to, with, or as a spray coolant for extruded fibers. Still further, these polycarbosilane-containing solutions can be added to pigments and/or fillers and stirred therewith for several, e.g., 2-3 minutes, or alternatively, these solutions can be added to an emulsion or other existing formulations prior to use or application.

Regardless of the application method, subsequent processing steps can be carried out to improve bonding. To illustrate by way of example, after treating the surface of a substrate, such as a fabric substrate, with a polycarbosilane solution in accordance with embodiments of the present invention, the surface can be heated to further complete bonding of the compound, product, or composition to the surface of the substrate. Alternatively, exposure to acids, bases, or tin catalysts will accelerate the condensation process.

Other materials can also be co-applied with the materials of the present invention. For example, stabilizing compounds and methods can be used in addition to or in conjunction with various art-known stabilization methods for organosilanes, such as the use of ionic or non-ionic surfactants and detergents. Further, as is well known in the art, certain classes of organosilanes have properties which can repel water and other liquids. Accordingly, one embodiment of the present invention can include application of the coating(s) of the present invention for treating a substrate to render the substrate resistant to stains.

Treating polymers and other substrates, such as concrete, by incorporation of the materials of the present invention into the bulk materials of the substrate prior to formation or setting can protect products resulting therefrom from deterioration, odor build-up, and potentially harmful contamination of the surface. For example, the incorporation of a polycarbosilane-bound UV stabilizer into polymers and/or concrete can provide protection from the sun and/or can extend the life of the resulting product.

Suitable polycarbosilane precursors that can be used to form a barrier layer and/or a functional layer in accordance with embodiments of the present invention include tetrakis-(trichlorosilylethyl)silane, trichlorosilylethyl-tris-(trichlorosilylpropyl)silane and tetrakis-(triethoxysilylethyl)silane, including their partially hydrolyzed forms. Others include tetra(trichlorosilylpropyl)silane, octadecyl-tris-(trichlorosilylethyl)silane, octadecyl-tris-(trichlorosilylpropyl)silane, tridecafluorooctyl-tris-(trichlorosilylethyl)silane, tridecafluorooctyl-tris-(triethoxysilylethyl)silane, and partially hydrolyzed forms thereof. These materials have from two (2) to three (3) carbon alkylene group spacers, though generally, shorter alkylene groups, e.g., two (2), can sometimes be more stable. Though specific examples are provided for coating various substrates, these materials and their analogs, extensions, alternate leaving groups, etc., can also be used as replacements for silicate primers providing a coating base for attaching other materials thereto.

As the compositions of the present invention have more than the typical three potential attachment points, the coatings of the present invention impart much more adherence strength and durability than the silanes that have been previously used as coating materials. For example, each polycarbosilane group of the present invention can be attached (to one another and/or to a substrate surface) at nine or more locations rather than three. To illustrate other advantages, the extent of crosslinking or the density of the coating film and its permeability can be a direct function of the type of silane used, as well as the method under which it is applied. As nine or more bonding points are available with the materials of the present invention, the bonding points not only attach to the surface but can also bond to one another, producing a much more durable film.

### EXAMPLES

The following examples illustrate the embodiments of the invention that are presently best known. However, it is to be understood that the following are only exemplary or illustrative of the application of the principles of the present invention. Numerous modifications and alternative compositions, methods, and systems may be devised by those skilled in the art without departing from the spirit and scope of the present invention. The appended claims are intended to cover such modifications and arrangements. Thus, while the present invention has been described above with particularity, the following examples provide further detail in connection with what are presently deemed to be the most practical and preferred embodiments of the invention.

### Example 1

### Particle Stability at High Temperature

A material prepared as approximated by the sectional representation of Formula 4 was found to be very stable in aggressive leaching conditions. Specifically, the material of Formula 4 was thermally treated and packed into stainless steel tubes and subjected to a flow of superheated water at 200° C. The liquid state of the water was maintained through use of a backpressure regulator set at 250 psi. No visible change or compaction of the bed was evident after 10,000 column volumes of superheated water were passed through the material.

### Example 2

### Preparation of Vinyltriallylsilane

About 181 ml of 2 M allylmagnesium chloride in tetrahydrofuran (Aldrich) was transferred under nitrogen into a 250 ml flask and cooled in dry ice to −78° C. Slowly, 16.5 grams of vinyltrichlorosilane was transferred into the flask with continuous shaking. Solids developed and heat was generated. The solution/slurry was allowed to warm to room temperature and then was slowly added to 500 ml water. Again, heat was generated. About 20 ml of acetic acid was added to dissolve precipitated magnesium salts. The organic fraction was then separated, the aqueous portion washed 3 times with 20 ml portions of methylene chloride, and the organic fractions were combined. The compositions were washed with two separate portions of water, 20 ml each, and the organic fraction dried to a degree by filtration through 5 ml of silica gel. The product was distilled, and the main fraction, which was boiling at 188° C., was collected.

### Example 3

### Preparation of Hydrosilation Product with Trichlorosilane

Approximately 15 grams of vinyltriallylsilane as prepared in Example 2 above was introduced into a vial with magnetic stir bar. The contents were sparged with nitrogen for 45 minutes at 50° C. The contents were then cooled with dry ice and 10 grams of trichlorosilane were transferred into the vial with nitrogen pressure. A syringe loaded with 20 microliters of chloroplatinic acid solution (1 wt % in 1 wt % ethanol/99 wt % tetrahydrofuran, giving ˜0.5 wt % platinum) was used for catalyst introduction. The mixture was heated under pressure to 80° C. to 90° C. and sampled periodically for capillary SFC analysis. Additional trichlorosilane was added until about 45 grams total had been added. The reaction progress showed a decrease in starting olefinicsilane and increasing concentrations of trichlorosilane adducts. Every two days, additional 20 microliters of catalyst were added and the reaction continued. After 7 days, the excess trichlorosilane was distilled off leaving straw colored oil. The product was sparged with dry nitrogen to remove volatiles to a pot temperature of ˜200° C. A product distribution with multiple trichlorosilane groups present was formed.

### Example 4

### Preparation of Octadecyltriallylsilane

Approximately 50 grams of distilled octadecyltrichlorosilane was slowly added to approximately 200 ml of 2 M allylmagnesium chloride in tetrahydrofuran with dry ice cooling. A nitrogen atmosphere was maintained. After addition was complete, the mixture was allowed to warm to room temperature and stand overnight. The slurry of product and dissolved salts was added slowly to water acidified by the addition of acetic acid. An oily layer separated on top, which was removed and washed twice with 100 ml of water for each wash. The product was dried by the addition of solid NaCl and filtered to give straw colored oil.

### Example 5

### Preparation of Hydrosilation Product with Trichlorosilane

Approximately 15 grams of octadecyltriallylsilane prepared in accordance with Example 4 was introduced into a vial with magnetic stir bar. The contents were sparged with nitrogen for 45 minutes at 50° C. The contents were then cooled with dry ice and 20 grams of trichlorosilane (˜30% excess) were transferred into the vial with nitrogen pressure. A syringe loaded with 20 microliters of chloroplatinic acid solution (1 wt % in 1 wt % ethanol/99 wt % tetrahydrofuran, giving ˜0.5 wt % platinum) was used for catalyst introduction. The mixture was heated under pressure to 80° C. to 90° C. and sampled periodically for capillary SFC analysis. The reaction progress showed a decrease in starting olefinicsilane and increasing concentrations of trichlorosilane adducts. Every two days, additional 20 microliters of catalyst were added and the reaction continued. After 7 days, the excess trichlorosilane was distilled off leaving a straw colored oil. The product was sparged with dry nitrogen to remove volatiles to a pot temperature of ˜200° C.

### Example 6

### Preparation of Polycarbosilane-Treated Silica Particles

Silica particles (SMB, 3 μm spherical, 100 Angstrom pore size, from Fuji Silicia) were dried under vacuum at 200° C. overnight. To 3 grams of this material in a glass vial was added 5 grams of dried toluene and 2 grams of the octadecyltriallylsilane/trichlorosilane hydrosilation product of Example 5. An atmosphere of dry nitrogen was maintained over the slurry. The mixture was heated to 110° C. and stirred with a magnetic teflon-coated stir bar. After 5 hours, 2 grams of dried pyridine were added and heating and stirring continued overnight.

The slurry was filtered and the particles washed with dry toluene, followed by methanol (25 ml each). The particles were loosely packed into a stainless steel tube with 0.5 micron stainless steel frits on each end. The tube was placed in a Selerity Polaratherm oven, and 10,000 volumes of water was passed through the particles at 200° C. The apparatus was cooled, removed from the Polaratherm, and the particles dried overnight in a vacuum oven at 200° C. The treatment process was repeated as before with the same reagents to incorporate a second coating. The filtration, superheated water extraction, and drying steps were repeated.

### Example 7

### Column Stability at High Temperature and High Water Content

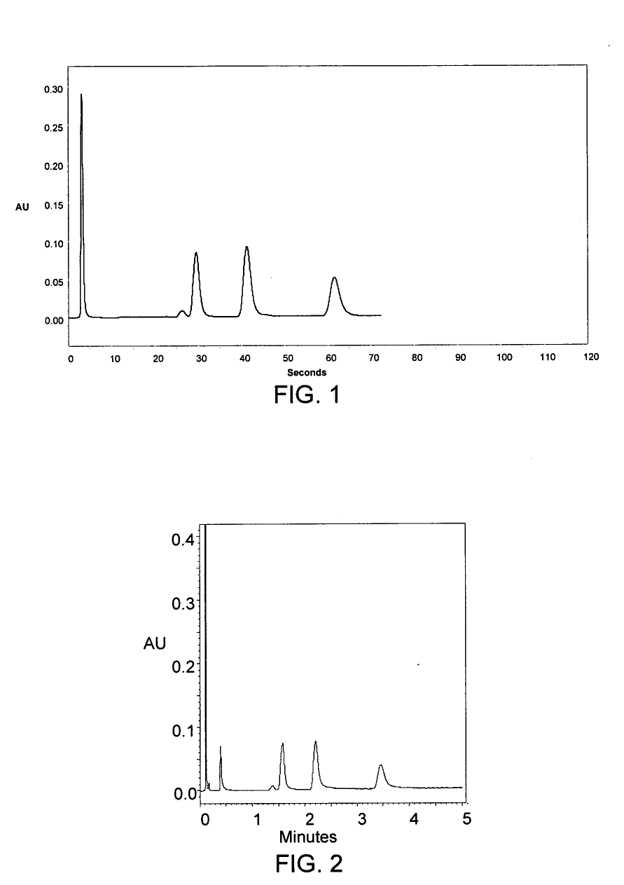

The particulates prepared in accordance with Example 6 were packed into stainless steel column housings at 10,000 psi with acetone as a slurry solvent and methanol as a push solvent. The housing dimensions were 2.1 mm inner diameter and 5 cm length. The column was installed in the Polaratherm and heated to 200° C. with an eluent of 5 wt % ACN in water at 4 ml/min. The system reported a backpressure of 3975 psi. A test mixture containing uracil, androstadienedione, androstenedione, and epitestosterone was analyzed with UV detection at 254 nm, as shown in FIG. 1. The column was stable during passage of at least several thousand column volumes of aqueous-based mobile phase at 200° C.

### Example 8

### Preparation of Multi-Layer Polycarbosilane-Treated Silica Particles

About 150 g of silica particles (Pinnacle II, 3 μm spherical, 110 Angstrom pore size, from Restek Corporation) was transferred into a 1 liter RB flask with 3 necks equipped with a Teflon/glass mechanical stirring paddle. The silica was suspended in about 600 ml of xylene. Heat was applied with stirring and water removed using a Dean-Stark condenser/trap. When water ceased being evolved, the Dean-Stark trap was replaced with a Soxhlet assembly containing dry 4A molecular sieves in the extraction thimble. Boiling xylene was cycled through the assembly for 3 hours to “polish” the suspension through removal of trace amounts of moisture.

A solution of 30.8 grams of distilled tetrakis-(trichlorosilylethyl)silane in about the same amount of dry xylene was slowly added to the rapidly stirred dry slurry through a dropping funnel. Dry pyridine was then added slowly to the suspension through a dropping funnel for a total of 35 grams. An exotherm occurred as the silane reacted with the silica particles and the HCl produced was scavenged by the pyridine. Reflux conditions were maintained through the Soxhlet assembly that was still in place from the drying step before. Pyridinium hydrochloride was co-distilled with the xylene and crystallized in the Soxhlet. This crystallization was desirable as its removal during the bonding process made filtration and cleanup of the particles much easier. The suspension was stirred and refluxed overnight.

A considerable quantity of pyridinium hydrochloride was present in the Soxhlet trap after 16 hours. The heat was removed and the suspension allowed to come to room temperature. The Soxhlet was removed and cleaned, and the silica suspension was filtered through a pressure filter to remove excess reagent. The filter cake was washed twice with 300 ml portions of dry xylene and then twice with 300 ml portions of dry tetrahydrofuran. This left a highly chlorinated silica surface from bound tetrakis-(trichlorosilylethyl)silane. Hydrochloric acid (HCl) was released on exposure to atmospheric moisture. The particles were transferred back into the 1 liter RB flask fitted with a condenser for controlled hydrolysis.

The particles were re-suspended in about 600 ml of xylene, and then stirring and refluxing was begun. About 40 ml of water slowly added through a dropping funnel. Hydrogen chloride gas was evolved which was scrubbed through an appropriate trapping system. When HCl gas evolution slowed, excess pyridine was slowly added through a dropping funnel to finish the hydrolysis reaction. Pyridine addition was carefully controlled because the hydrolysis was exothermic.

A distillation head was installed and water, THF (residual from the filtrate washing step earlier), and excess pyridine were removed. Distillation was continued until the head reached the temperature of refluxing xylene. A clean insulated Soxhlet assembly with dry molecular sieves was again installed, and traces of water removed by refluxing the solution through the extractor. The solution was allowed to cycle for 3 hours, during which time some condensation of surface silanol groups within the barrier layer occurred, generating more water that was swept from the system and trapped, and where more pyridinium hydrochloride sublimed into the extractor.

To this composition was added more tetrakis-(trichlorosilylethyl)silane (30.8 gm) in xylene through a dropping funnel and the process was repeated (from the prior addition of 30.8 gm of tetrakis-(trichlorosilylethyl)silane above) to form a second layer. After this second (barrier) layer was filtered, washed, hydrolyzed, condensed, and the slurry again dried, it was ready for functionalization with C₁₈ groups.

A total of 52.2 grams of octadecyl-tris-(2-trichlorosilylethyl)silane was added slowly to the stirred, refluxing, dried, xylene slurried particles. This third addition was a third layer which would become a functional polycarbosilane layer. Dry pyridine (39 grams) was added slowly. An exotherm occurred and the slurry was refluxed through the Soxhlet. The slurry was mechanically stirred and refluxed overnight. The Soxhlet was replaced with a distillation head and as much xylene was removed as possible without the slurry becoming too thick to stir. The vessel was then cooled and 400 ml dry THF was added. The product was filtered and the solids washed with 2 portions each of 300 ml THF. The product resulted in a three layered composition having two barrier layers and a third functional layer.

Next, the particles were conditioned by immediately loading them into prep-scale column housings for leaching. For the scale described herein, two 1 inch diameter by 24 inch length all-stainless steel columns with stainless steel frits were used to contain the particles. The columns were connected in series and a flow of water at 10 ml/min was started. When the columns were completely filled with water and the HCl evolution ceased (produced from hydrolysis of residual silicon chloride), the flow rate was dropped to 3 ml/min and the vessels were heated in an oven to 200° C. with the flow continuing. The heating with water flow was continued for 12 hours, and the water was then switched to acetonitrile and flow at 200° C. was continued for 8 more hours. The acetonitrile was removed from the particles by switching flow to carbon dioxide directly from a cylinder. The temperature was maintained at 200 degrees until acetonitrile no longer exited the outlet line. The carbon dioxide flow was discontinued, and the column housings were cooled to room temperature.

### Example 9

### Column Stability at High Temperature and High Water Content

The particulates prepared in accordance with Example 8 were packed into stainless steel column housings at 10,000 psi with acetone as a slurry solvent and methanol as a push solvent. The housing dimensions were 2.1 mm inner diameter and 5 cm length. The column was installed in the Polaratherm and heated to 200° C. with an eluent of 100% water at 4 ml/min. This test is similar to the test conducted in Example 7, except that the polycarbosilane-treated silica of Example 8 was used rather than the polycarbosilane-treated silica of Example 6. An additional difference was that 100% water was used as the eluent rather than a 5% solution of ACN. A test mixture containing uracil, androstadienedione, androstenedione, and epitestosterone was analyzed with UV detection at 254 nm, and the results are shown in FIG. 2. The column was stable during passage of at least several thousand column volumes of aqueous-based mobile phase at 200° C.

### Example 10

### Selectivity Determination

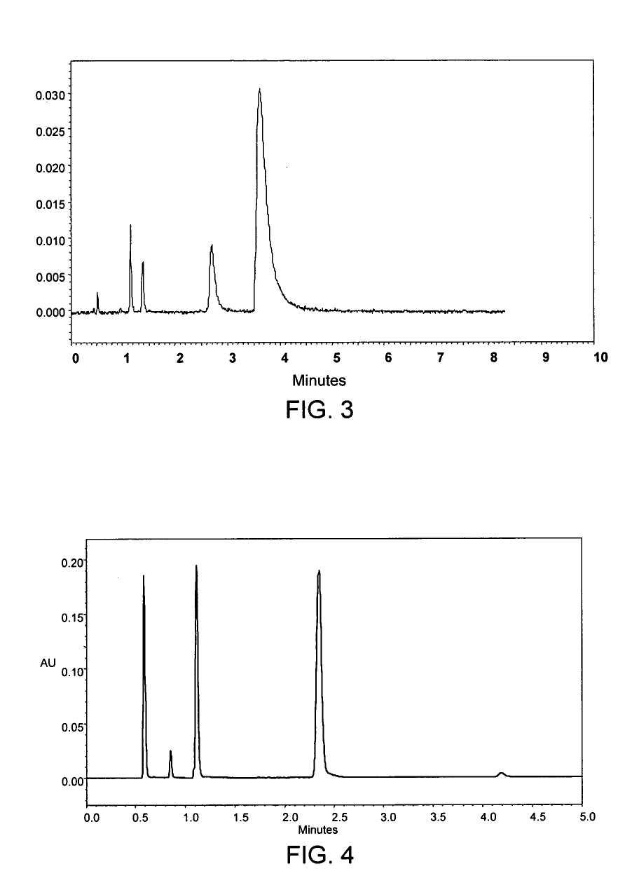

The particulates prepared in accordance with Example 8 were packed into stainless steel column housings at 10,000 psi with acetone as a slurry solvent and methanol as a push solvent. The housing dimensions were 4.6 mm inner diameter and 10 cm length. The column was installed in the Polaratherm at 25° C. with a mobile phase 80:20 methanol: 5 mM potassium phosphate pH 7 at 2 ml/min. The NIST 870 mixture was separated with UV detection at 254 nm, and the results are shown in FIG. 3. Specifically, tailing and asymmetry for amitryptyline indicate some silanol interaction, and peak shape and elution of quinizarin indicate low activity toward metal chelating agents. The overall selectivity was typical for octadecylsilane (ODS) treated silica.

### Example 11

### Separation of Analgesics at pH 1

The particulates prepared in accordance with Example 8 were packed into stainless steel column housings at 10,000 psi with acetone as a slurry solvent and methanol as a push solvent. The housing dimensions were 4.6 mm inner diameter and 10 cm length. The column was installed in the Polaratherm with an eluent of 40 wt % acetonitrile in water with 1 wt % TFA at 2 ml/min, and the temperature was held at 30° C. for 1 min and then raised 30° C. per min until a temperature of 110° C. was reached. A test mixture containing analgesics was separated into its component parts with the compounds eluting in the order: acetaminophen, aspirin, salicylic acid, naproxen, and ibuprofen. UV detection was used at 235 nm, and the results are shown in FIG. 4. The column was stable during passage of several thousand column volumes of aqueous-based mobile phase at 200° C.

### Example 12

### High pH Stability

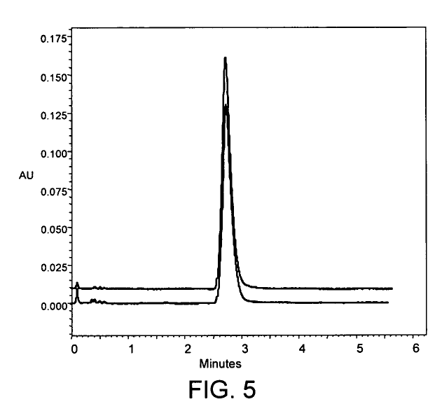

The particulates prepared in accordance with Example 8 were packed into stainless steel column housings at 10,000 psi with acetone as a slurry solvent and methanol as a push solvent. The housing dimensions were 2.1 mm inner diameter and 5 cm length. The column was installed in the Polaratherm at 40° C. with a mobile phase 50:50 ACN:50 mM pyrrolidine at pH 12 at 0.8 ml/min. The column was analyzed with UV detection at 254 nm, and the results are shown in FIG. 5. Specifically, the higher peak represented the results initially, and the lower peak is as recorded after 2500 columns were run. As can be seen, after 2500 columns, the polycarbosilane-modified solid supports eluted amitryptyline with the same retention and peak shape.

### Example 13

### Preparation of Barrier Coating

A small quantity (<0.3 gm) of tetrakis-(trichlorosilylethyl)silane, which is a tetracarbosilane material, was added to the inside of several Pyrex laboratory flasks. The solids were dissolved in methylene chloride and swirled to coat the flask bottom. The solvent was allowed to evaporate, and the residue exposed to laboratory air overnight. A film coated the bottom of the flasks that was translucent and slightly hazy. The flasks were filled with water and allowed to stand 2 hours, after which, the water was decanted. The film appeared unchanged after this treatment. The flasks were placed in an oven and heated to 200° C. in air. The film appeared unscathed. It was present as a hard, resinous layer that could not be removed with physical scraping with a metal spatula or scrubbing with Ajax™ cleanser (which contains abrasive particles and chlorine bleach). The layer formed was also largely unaffected by contact with boiling alcoholic potassium hydroxide (a common cleaning agent used for siloxane removal from glass), hot fuming nitric acid, hot concentrated sulfuric acid, 5% aqueous hydrofluoric acid, and “Pirhana” solution (which is hydrogen peroxide solution in concentrated sulfuric acid). The coatings on each flask also survived repeated thermal treatments to 400° C. in air. The only treatment found that was able to remove the layer was heating with hot Pirhana solution augmented by the addition of HF, which is a process known to oxidatively cleave Si—C bonds.

### Example 14

### Preparation of Barrier Coatings

The process of Example 13 was repeated with similar results, except that tetrakis-(triethoxysilylethyl)silane and tetrakis-(trichlorosilylpropyl)silane were used. With specific reference to the tetrakis-(triethoxysilylethyl)silane, similar to the chloro-silane bond, hydrolysis of the ethoxy-silane bond also occurs with the addition of water.

### Example 15

### Surface Treatment Comparative

Tridecafluorooctyl-tris-(triethoxysilylethyl)silane (Compound I) was prepared in a three-step reaction process from tridecafluorooctyltrichlorosilane using vinyl Grignard followed by hydrosilation with trichlorosilane and alcoholysis with ethanol. In other words, Compound I was prepared in accordance with embodiment of the present invention. For comparison purposes, the same tridecafluorooctyltrichlorosilane was also converted to the triethoxy analog by alcoholysis with ethanol (Compound II). Compound II has been used as a surface treatment to impart low surface energy and water repellency because of the perfluorinated hydrocarbon functionality that protrudes from its film. It was anticipated that Compound I would exhibit similar surface energy lowering and water repellency characteristics, but with enhanced durability.

With these preparations for comparison, a 5 wt % solution of each of Compound I and Compound II was prepared in ethanol and applied to adjacent areas of an automobile windshield that had been freshly cleaned with commercial glass cleaner. The application of the compounds was carried out by saturating a paper towel with the solution and wiping it over the surface. The environmental conditions were: temperature 29° F., near 100% relative humidity, and 10 mph wind. Upon application, the ethanol solution quickly evaporated, leaving a translucent haze on the windshield for each of Compound I and Compound II. After 5 minutes, the surface was polished first with a damp paper towel, and then with a dry one. The area treated with Compound I was more difficult to polish to a clear transparent surface than the area treated with Compound II, but yielded to firm pressure when wiping with the dry paper towel to form an essentially equally appearing polished film.

The windshield was subjected to snow, rain, ice, salt, and road dirt impingement while driving in winter conditions. In addition, the abrasive action of rubber windshield wiper blades was periodically applied. Initially, and after 1 week of exposure to adverse weather conditions, both areas appeared virtually identical with respect to wettability and water droplet contact angle. The glass surface was then cleaned with progressively more aggressive agents in an attempt to differentiate between the coatings. These included commercial glass cleaner (Windex™), sudsy ammonia solution, 50 mM phosphate solution at pH 12, and even 5% potassium hydroxide in methanol. In each case, vigorous wiping with a paper towel was employed, and the surface tested for wettability and water droplet contact angle. To this point, no difference was observed with either treated area, each still performing near to its original state.

Each area was then subject to the abrasive action of damp Ajax™ cleanser, by rubbing with firm pressure in a circular motion with a paper towel. The surface was then rinsed well with HPLC grade deionized water. The area treated with Compound II was effectively wetted by water at this point, forming a continuous film that drained smoothly from the glass (the surface was at a 45 degree vertical angle). The area with Compound I showed no difference from its initial state, still unwettable and intact as a continuous barrier film.

While the invention has been described with reference to certain preferred embodiments, those skilled in the art will appreciate that various modifications, changes, omissions, and substitutions can be made without departing from the spirit of the invention. It is therefore intended that the invention be limited only by the scope of the appended claims.

1. A polycarbosilane functionalized substrate, comprising:
a) a substrate including a surface having surface oxide or surface hydroxyl groups; and
b) a polycarbosilane layer covalently bonded to the surface, said polycarbosilane layer including a web of interconnected polycarbosilane groups, wherein carbon linking portions of the polycarbosilane groups are alkylene moieties.

2. A polycarbosilane functionalized substrate as in claim 1, wherein the surface includes a metal oxide.

3. A polycarbosilane functionalized substrate as in claim 1, wherein the surface includes a semi-metal oxide.

4. A polycarbosilane functionalized substrate as in claim 1, wherein the substrate is a chromatographic solid support material.

5. A polycarbosilane functionalized substrate as in claim 4, wherein the chromatographic solid support material is selected from the group consisting of silica, silicates, zirconia, titania, alumina, ceramic supports, glass supports, and combinations thereof.

6. A polycarbosilane functionalized substrate as in claim 1, wherein the substrate is selected from the group consisting of glass, fiberglass, silica, aluminum and its alloys, steel, stainless steel, magnesium and its alloys, brass, copper, bronze, marble, concrete, siliceous minerals, limestone, carbon fiber, carbon black, cotton fiber, silicon carbide, and combinations thereof.

7. A polycarbosilane functionalized substrate as in claim 1, wherein the substrate is selected from the group consisting of paper, wood, plastic, phenolics, acrylates, polyolefins, polystyrenes, epoxies, urea-formaldehyde and combinations thereof.

8. A polycarbosilane functionalized substrate as in claim 1, wherein the polycarbosilane groups include tricarbosilanes.

9. A polycarbosilane functionalized substrate as in claim 1, wherein the polycarbosilane groups include tetracarbosilanes.

10. A polycarbosilane functionalized substrate as in claim 1, wherein the polycarbosilane groups include at least one member selected from the group consisting of pentacarbosilanes, hexacarbosilanes, heptacarbosilanes, octacarbosilanes, nonacarbosilanes, and decacarbosilanes.

11. A polycarbosilane functionalized substrate as in claim 10, wherein the at least one member is a pentacarbosilane.

12. A polycarbosilane functionalized substrate as in claim 10, wherein the at least one member is a hexacarbosilane.

13. A polycarbosilane functionalized substrate as in claim 1, wherein the polycarbosilane layer is a polycarbosilane barrier layer.

14. A polycarbosilane functionalized substrate as in claim 1, wherein the polycarbosilane layer is a polycarbosilane functional layer.

15. A polycarbosilane functionalized substrate as in claim 1, wherein the web of interconnected polycarbosilane groups is covalently bonded to the surface through tethering silicon-oxygen bonds.

16. A polycarbosilane functionalized substrate as in claim 15, wherein at least one of the polycarbosilane groups is tethered to the surface through two or three alkylenesilane moieties, forming at least one tethering silicon-oxygen bond through each of the two or three alkylenesilane moieties.

17. A polycarbosilane functionalized substrate as in claim 16, wherein at least one of the two or three alkylenesilane moieties individually forms two or three tethering silicon-oxygen bonds.

18. A polycarbosilane functionalized substrate as in claim 1, wherein the web of interconnecting polycarbosilane groups includes a first polycarbosilane group that is bonded to a second polycarbosilane group through a first linking siloxane bond.

19. A polycarbosilane functionalized substrate as in claim 18, wherein the web of interconnecting polycarbosilane groups further includes a third polycarbosilane group and a fourth polycarbosilane group, wherein the third polycarbosilane group is bonded to the first polycarbosilane group through a second linking siloxane bond, and wherein the fourth polycarbosilane group is bonded to the second polycarbosilane group through a third linking siloxane bond.

20. A polycarbosilane functionalized substrate as in claim 19, wherein the first polycarbosilane group and the second polycarbosilane group are further bonded through a fourth linking siloxane bond.

21. A polycarbosilane functionalized substrate as in claim 1, wherein the web of interconnected polycarbosilane groups includes organosilane groups that are hydroxylated.

22. A polycarbosilane functionalized substrate as in claim 1, wherein the web of interconnected polycarbosilane groups include organosilane groups having reactive leaving groups, said leaving groups being selected from the group consisting of halogens, triflates, alkoxy, acyl, oximes, amines, and amine salts.

23. A polycarbosilane functionalized substrate as in claim 1, wherein the alkylene moieties range from C₂ to C₆.

24. A polycarbosilane functionalized substrate as in claim 14, wherein the polycarbosilane functional layer includes tricarbosilane groups, at least a portion of the tricarbosilane groups including an alkylene group that is terminated by a functional or bulky group.

25. A polycarbosilane functionalized substrate as in claim 24, wherein the functional or bulky group is selected from the group consisting methyl, ethyl, straight or branched C₃ to C₃₀ alkyl, hydroxy-substituted alkyl, cyanoalkyl, fluoroalkyl, mercaptoalkyl, ester-substituted alkyl, carboxylic acid substituted alkyl, aminoalkyl, ether-substituted alkyl, epoxy-substituted alkyl, silyl-substituted alkyl, phosphinoalkyl, phenyl and substituted phenyl, and combinations thereof.

26. A polycarbosilane functionalized substrate as in claim 1, wherein the substrate and the polycarbosilane layer form a composite matrix.

27. A polycarbosilane functionalized substrate as in claim 1, wherein the substrate is a composite matrix, and the polycarbosilane layer is incorporated into the composite matrix.

28. A polycarbosilane functionalized substrate, comprising:
a) a substrate including a surface having surface oxide or surface hydroxyl groups;
b) a first polycarbosilane layer covalently bonded to the surface, said first polycarbosilane layer including a first web of interconnected polycarbosilane groups bonded to the surface; and
c) a second polycarbosilane layer covalently bonded to the first polycarbosilane layer, said second polycarbosilane layer including a second web of interconnected polycarbosilane groups, wherein carbon linking portions of the polycarbosilane groups of the first and second webs are alkylene moieties.

29. A polycarbosilane functionalized substrate as in claim 28, wherein the surface includes a metal oxide.

30. A polycarbosilane functionalized substrate as in claim 28, wherein the surface includes a semi-metal oxide.

31. A polycarbosilane functionalized substrate as in claim 28, wherein the substrate is a chromatographic solid support material.

32. A polycarbosilane functionalized substrate as in claim 31, wherein the chromatographic solid support material is selected from the group consisting of silica, silica gel, silicates, zirconia, titania, alumina, nickel oxide, ceramic supports, glass supports, and combinations thereof.

33. A polycarbosilane functionalized substrate as in claim 28, wherein the substrate is selected from the group consisting of glass, fiberglass, silica, aluminum and its alloys, steel, stainless steel, magnesium and its alloys, brass, copper, bronze, marble, concrete, siliceous minerals, limestone, carbon fiber, carbon black, cotton fiber, silicon carbide, and combinations thereof.

34. A polycarbosilane functionalized substrate as in claim 28, wherein the substrate is selected from the group consisting of paper, wood, plastic, phenolics, acrylates, polyolefins, polystyrenes, epoxies, urea-formaldehyde and combinations thereof.

35. A polycarbosilane functionalized substrate as in claim 28, wherein the polycarbosilane groups include tricarbosilanes.

36. A polycarbosilane functionalized substrate as in claim 28, wherein the polycarbosilane groups include tetracarbosilanes.

37. A polycarbosilane functionalized substrate as in claim 28, wherein the polycarbosilane groups include at least one member selected from the group consisting of pentacarbosilanes, hexacarbosilanes, heptacarbosilanes, octacarbosilanes, nonacarbosilanes, and decacarbosilanes.

38. A polycarbosilane functionalized substrate as in claim 37, wherein the at least one member is a pentacarbosilane.

39. A polycarbosilane functionalized substrate as in claim 37, wherein the at least one member is a hexacarbosilane.

40. A polycarbosilane functionalized substrate as in claim 28, wherein the first polycarbosilane layer is a polycarbosilane barrier layer.

41. A polycarbosilane functionalized substrate as in claim 28, wherein the second polycarbosilane layer is a polycarbosilane functional layer.

42. A polycarbosilane functionalized substrate as in claim 28, wherein the polycarbosilane groups used to form the first web of interconnected polycarbosilane groups are the same as the polycarbosilane groups used to form the second web of interconnected polycarbosilane groups.

43. A polycarbosilane functionalized substrate as in claim 28, wherein the polycarbosilane groups used to form the first web of interconnected polycarbosilane groups are different than the polycarbosilane groups used to form the second web of interconnected polycarbosilane groups.

44. A polycarbosilane functionalized substrate as in claim 28, wherein the first web of interconnected polycarbosilane groups is covalently bonded to the surface through tethering silicon-oxygen bonds.

45. A polycarbosilane functionalized substrate as in claim 44, wherein the second web of interconnected polycarbosilane groups is covalently bonded to the first web of interconnected polycarbosilane groups through linking siloxane bonds.

46. A polycarbosilane functionalized substrate as in claim 44, wherein at least one of the polycarbosilane groups of the first web is tethered to the surface through two or three alkylenesilane moieties, forming at least one tethering silicon-oxygen bond through each of the two or three alkylenesilane moieties.

47. A polycarbosilane functionalized substrate as in claim 46, wherein at least one of the two or three alkylenesilane moieties individually forms two or three tethering silicon-oxygen bonds.

48. A polycarbosilane functionalized substrate as in claim 46, wherein at least one of the two or three alkylenesilane moieties of the first web individually forms two or three tethering siloxane bonds.

49. A polycarbosilane functionalized substrate as in claim 40, wherein individual polycarbosilane groups of the polycarbosilane barrier layer are bonded to one another through one or two linking siloxane bonds.

50. A polycarbosilane functionalized substrate as in claim 41, wherein individual polycarbosilane groups of the polycarbosilane functional layer are bonded to one another through one or two linking siloxane bonds.

51. A polycarbosilane functionalized substrate as in claim 28, wherein the first web and the second web of interconnected polycarbosilane groups each include organosilane groups that are hydroxylated.

52. A polycarbosilane functionalized substrate as in claim 28, wherein the first web and the second web of interconnected polycarbosilane groups includes organosilane groups having reactive leaving groups, said leaving groups being selected from the group consisting of halogens, triflates, alkoxy, acyl, oximes, amines, and amine salts.

53. A polycarbosilane functionalized substrate as in claim 28, wherein the alkylene moieties range in length from C₂ to C₆.

54. A polycarbosilane functionalized substrate as in claim 41, wherein the polycarbosilane functional layer includes tricarbosilane groups, at least a portion of the tricarbosilane groups including an alkylene group that is terminated by a functional or bulky group.

55. A polycarbosilane functionalized substrate as in claim 54, wherein the functional or bulky group is selected from the group consisting methyl, ethyl, straight or branched C₃ to C₃₀ alkyl, hydroxy-substituted alkyl, cyanoalkyl, fluoroalkyl, mercaptoalkyl, ester-substituted alkyl, carboxylic acid substituted alkyl, aminoalkyl, ether-substituted alkyl, epoxy-substituted alkyl, silyl-substituted alkyl, phosphinoalkyl, phenyl and substituted phenyl, and combinations thereof.

56. A polycarbosilane functionalized substrate as in claim 28, wherein the substrate and the polycarbosilane layer form a composite matrix.

57. A polycarbosilane functionalized substrate as in claim 28, wherein the substrate is a composite matrix, and the polycarbosilane layer is incorporated into the composite matrix.

58. A polycarbosilane functionalized substrate as in claim 28, further comprising a third polycarbosilane layer covalently bonded to at least one of the first or second polycarbosilane layer, said third polycarbosilane layer including a third web of interconnected polycarbosilane groups, wherein carbon linking portions of the polycarbosilane groups of the third web are alkylene moieties.

59. A tricarbosilane precursor, comprising the structure: 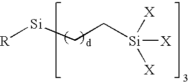
wherein each d is independently from 1 to 4, each X is independently halogen, triflate, alkoxy, acyl, oxime, amine, amine salt, C₁ to C₃₀ alkyl, C₂ to C₆ alkylenesilyl, or carbosilane, wherein at least one X is halogen, triflate, alkoxy, acyl, oxime, amine, or amine salt, and R is methyl, ethyl, straight or branched C₃ to C₃₀ alkyl, hydroxy-substituted alkyl, cyanoalkyl, fluoroalkyl, mercaptoalkyl, ester-substituted alkyl, carboxylic acid substituted alkyl, aminoalkyl, ether-substituted alkyl, epoxy-substituted alkyl, silyl-substituted alkyl, phosphinoalkyl, phenyl and substituted phenyl, and combinations thereof.

60. A tricarbosilane precursor as in claim 59, wherein R is straight or branched C₈ to C₃₀ alkyl, hydroxy-substituted alkyl, cyanoalkyl, fluoroalkyl, mercaptoalkyl, ester-substituted alkyl, carboxylic acid substituted alkyl, aminoalkyl, ether-substituted alkyl, epoxy-substituted alkyl, silyl-substituted alkyl, phosphinoalkyl, phenyl and substituted phenyl, and combinations thereof.

61. A tricarbosilane precursor as in claim 59, wherein R is from C₄ to C₁₈.

62. A tricarbosilane precursor as in claim 59, wherein R is C₈.

63. A tricarbosilane precursor as in claim 59, wherein R is C₁₈.

64. A tricarbosilane precursor as in claim 59, wherein X is chloro.

65. A tricarbosilane precursor as in claim 59, wherein at least one X is also a carbosilane such that the precursor becomes at least a tetracarbosilane.

66. A method of preparing a polycarbosilane functionalized solid support, comprising:
forming a first group of polycarbosilane precursor monomers;
attaching the first group of polycarbosilane precursor monomers to a substrate including a surface having surface oxide or surface hydroxyl groups, said first group of polycarbosilane precursor monomers being attached to said surface through tethering silicon-oxygen bonds; and
forming a first web of interconnected polycarbosilane groups from the first group of polycarbosilane precursor monomers, said first web including linking siloxane bonds interconnecting adjacent polycarbosilane groups.

67. A method as in claim 66, wherein the surface includes silanol moieties, and Wherein the tethering silicon-oxygen bonds are siloxane bonds.

68. A method as in claim 67, wherein the first group of polycarbosilane precursor monomers, respectively, have the structure: 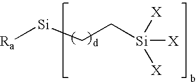
wherein when a is 0, b is 4, and when a is 1, b is 3; each d is independently from 1 to 4; each X is independently halogen, triflate, alkoxy, acyl, oxime, amine, amine salt, C₁ to C₃₀ alkyl, C₂ to C₆ alkylenesilyl, or carbosilane, wherein at least one X is halogen, triflate, alkoxy, acyl, oxime, amine, or amine salt; and R, if present, is methyl, ethyl, straight or branched C₃ to C₃₀ alkyl, hydroxy-substituted alkyl, cyanoalkyl, fluoroalkyl, mercaptoalkyl, ester-substituted alkyl, carboxylic acid substituted alkyl, aminoalkyl, ether-substituted alkyl, epoxy-substituted alkyl, silyl-substituted alkyl, phosphinoalkyl, phenyl and substituted phenyl, and combinations thereof.

69. A method as in claim 66, wherein R is from C₄ to C₁₈.

70. A method as in claim 66, further comprising the step of hydroxylating the first web of interconnected polycarbosilane groups.

71. A method as in claim 70, further comprising the steps of:
attaching a second group of polycarbosilane precursor monomers to the hydroxylated first web through linking siloxane bonds; and
forming a second web of interconnected polycarbosilane groups from the second group of polycarbosilane precursor monomers, said second web including linking siloxane bonds interconnecting adjacent polycarbosilane groups.

72. A method as in claim 71, further comprising the step of hydroxylating the second web of interconnected polycarbosilane groups.

73. A method as in claim 66, wherein the first web is a polycarbosilane barrier layer.

74. A method as in claim 72, wherein the second web is a polycarbosilane functional layer.

75. A method as in claim 72, wherein the second web is a polycarbosilane barrier layer.

76. A method as in claim 72, further comprising the steps of:
attaching a third group of polycarbosilane precursor monomers to the hydroxylated first or second web through linking siloxane bonds; and
forming a third web of interconnected polycarbosilane groups from the third group of polycarbosilane precursor monomers, said third web including linking siloxane bonds interconnecting adjacent polycarbosilane groups.
